(19) United States
(12) Patent Application Publication
(10) Pub. No.: US 2024/0425012 A1
(43) Pub. Date: Dec. 26, 2024

(54) DRIVING VIOLATION PREVENTION SYSTEM

(71) Applicant: Vincenzo D' Arienzo, Kirkland (CA)

(72) Inventor: Vincenzo D' Arienzo, Kirkland (CA)

(21) Appl. No.: 18/213,008

(22) Filed: Jun. 22, 2023

(51) Int. Cl. B60R 25/045; B60Q 9/00; G06Q 50/26

(52) U.S. Cl. CPC B60R 25/045; B60Q 9/00; G06Q 50/265

(57) ABSTRACT

A driving violation prevention system for preventing ignition of a motor vehicle when a centralized database indicates a license is not valid includes a license with a machine-readable identification code, a switch enabling ignition of a motor vehicle when activated, and a reader. The reader compares the identification code of the license with information from a database indicating if the license is valid for permitting the associated user to drive. If the license is valid, the switch is activated, thereby allowing ignition of the motor vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to driving violation prevention systems and more particularly pertains to a new driving violation prevention system for preventing ignition of a motor vehicle when a centralized database indicates a license is not valid.

### (2) Description of Related Art Including Information Disclosed Under 37 CFR 1.97 and 1.98

The prior art relates to driving violation prevention systems which prevent operation of a vehicle or alert law enforcement upon identifying a violation or determining that a driver is not permitted to drive the vehicle. The devices disclosed in the prior art address this generic goal in a variety of strategies. One device, for example, limits operation of a vehicle at certain times of the day if the driver is wearing an anklet that indicates they have been placed on such a restriction. Another device prevents operation of the vehicle if the license plate is not affixed properly. Other devices prevent operation of the vehicle if data in a storage device kept on the vehicle indicates that the individual is not permitted to operate it. However, the prior art does not disclose a device which utilizes a radio-frequency identification means to identify the license, compare the license to data in a remote, centralized database to determine whether the driver is permitted to operate the vehicle, then enable ignition of the vehicle if the driver is permitted to operate.

### BRIEF SUMMARY OF THE INVENTION

An embodiment of the disclosure meets the needs presented above by generally comprising a license with a machine-readable identification code, a switch enabling ignition of a motor vehicle when activated, and a reader. The reader compares the identification code of the license with information from a database indicating if the license is valid for permitting the associated user to drive. If the license is valid, the switch is activated, thereby allowing ignition of the motor vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a diagram view of a driving violation prevention system according to an embodiment of the disclosure.

FIG. 2 is a front view of a reader of an embodiment of the disclosure.

FIG. 3 is an in-use view of an embodiment of the disclosure.

### DETAILED DESCRIPTION OF THE INVENTION

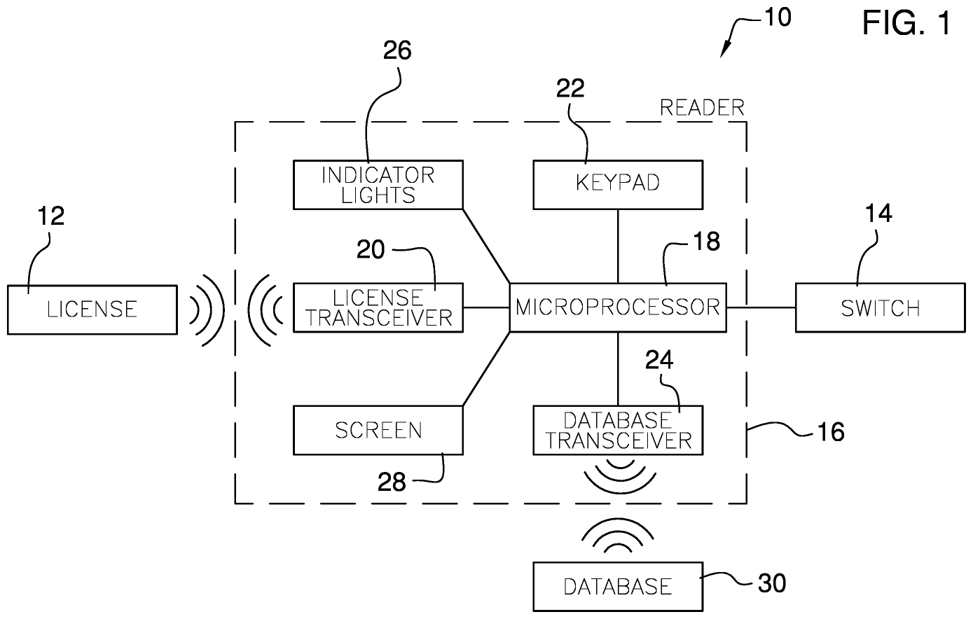

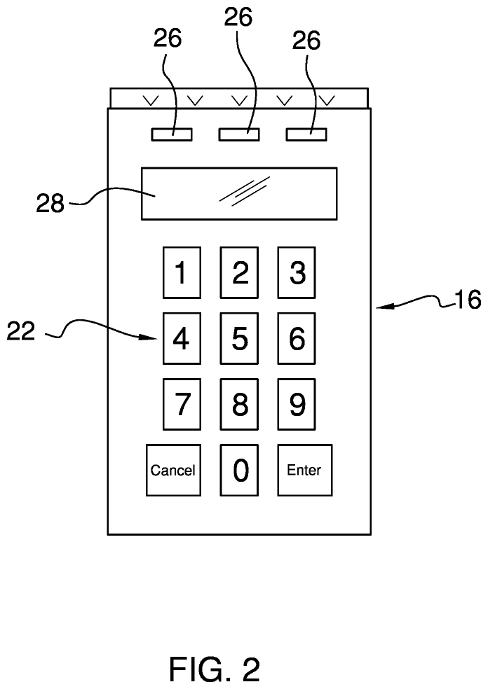

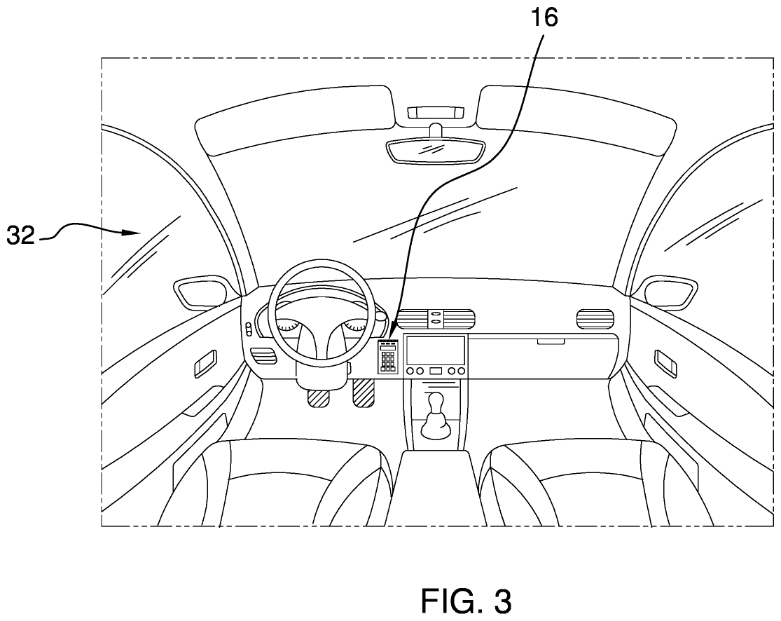

With reference now to the drawing, and in particular to FIGS. 1 through 3 thereof, a new driving violation prevention system embodying the principles and concepts of an embodiment of the disclosure and generally designated by the reference numeral 10 will be described.

As best illustrated in FIGS. 1 through 3, the driving violation prevention system 10 generally comprises a license 12 comprising an identification code, wherein the identification code is formatted in a machine-readable medium. A switch 14 has an open position and a closed position, and the switch 14 disables ignition of a motor vehicle 32 when open, while enabling ignition of the motor vehicle 32 when closed. The switch 14 is biased toward the open position.

A reader 16 is operationally coupled to the switch 14. The reader 16 wirelessly reads the identification code when the license 12 is positioned in a reading position. The reader 16 is also capable of receiving a keyed input and is configured for wirelessly transmitting a query signal to a database 30 requesting a determination of whether the keyed input is associated with the license 12 and whether the license 12 is valid for permitting an associated user to drive the motor vehicle 32. The reader 16 is configured to then wirelessly receive a validation-rejection signal from the database 30 indicating whether the keyed input is associated with the license 12, whether the license 12 is valid for permitting the associated user to drive the motor vehicle 32, and whether the license 12 will no longer be valid for permitting the associated user to drive the motor vehicle 32 if a condition is not met within a predetermined time period. The latter condition could result, for example, when the associated user owes a fine, the nonpayment of which by a certain date resulting in revocation of the associated user's license 12. The reader 16 closes the switch 14 when the validation-rejection signal indicates that the keyed input is associated with the license 12 and the license 12 is valid for permitting the associated user to drive the motor vehicle 32.

The reader 16 comprises a microprocessor 18, a license transceiver 20, a keypad 22, a database transceiver 24, a plurality of indicator lights 26, and a screen 28. The microprocessor 18 is operationally coupled to the switch 14 and closes the switch 14 when the validation-rejection signal indicates that the keyed input is associated with the license 12 and the license 12 is valid for permitting the associated user to drive the motor vehicle 32. The license transceiver 20 is operationally coupled to and in signal communication with the microprocessor 18. The license transceiver 20 wirelessly transmits an interrogation signal to the license 12 when the license 12 is positioned in the reading position. The license transceiver 20 wirelessly receives an identification signal comprising the identification code from the license 12 in response to the interrogation signal. then the license transceiver 20 sends the identification code to the microprocessor 18. The interrogation signal and the identification signal each operate using a radio frequency. Alternatively, the reader 16 and license 12 may use an alternative machine-readable medium, such as a bar code, magnetic strip, or the like.

The keypad 22 is operationally coupled to and in signal communication with the microprocessor 18. The keypad 22 is configured for receiving the keyed input from the associated user. Then the keypad 22 sends the keyed input to the microprocessor 18. The database transceiver 24 is also operationally coupled to and in signal communication with the microprocessor 18. The database transceiver 24 receives the identification code and the keyed input from the microprocessor 18 and is configured for wirelessly transmitting the query signal to the database 30 and receiving the validation-rejection signal from the database 30. The database transceiver 24 is also configured for sending the validation-rejection signal to the microprocessor 18.

The plurality of indicator lights 26 is operationally coupled to the microprocessor 18 and emits a validation light signal if the keyed input is associated with the license 12, the license 12 is valid for permitting the associated user to drive the motor vehicle 32, and the switch 14 is closed. The plurality of indicator lights 26 emits a rejection light signal if the switch 14 is open and either of the keyed input is not associated with the license 12, the license 12 is not valid for permitting the associated user to drive the motor vehicle 32, or both. The plurality of indicator lights 26 also emits a warning light signal if the keyed input is associated with the license 12, the license 12 is valid for permitting the associated user to drive the motor vehicle 32, the switch 14 is closed, and the license 12 will no longer be valid for permitting the associated user to drive the motor vehicle 32 if the condition is not met within the predetermined time period.

The screen 28 is operationally coupled to the microprocessor 18. The screen 28 displays a validation message if the keyed input is associated with the license 12, the license 12 is valid for permitting the associated user to drive the motor vehicle 32, and the switch 14 is closed. The screen 28 displays a rejection message if the switch 14 is open and either the keyed input is not associated with the license 12, the license 12 is not valid for permitting the associated user to drive the motor vehicle 32, or both. The screen 28 displays a warning message if the keyed input is associated with the license 12, the license 12 is valid for permitting the associated user to drive the motor vehicle 32, the switch 14 is closed, and the license 12 will no longer be valid for permitting the associated user to drive the motor vehicle 32 if the condition is not met within the predetermined time period.

In use, the associated user places the license 12 in the reading position. In this position, the license transceiver 20 of the reader 16 transmits the interrogation signal to the license 12, which triggers the transmission of the identification signal back to the license transceiver 20. The associated user also inputs the keyed input into the keypad 22. The database transceiver 24 wirelessly transmits the query signal to the database 30 and receives the validation-rejection signal from the database 30 in response, indicating whether the keyed input is associated with the license 12, whether the license 12 is valid for permitting the associated user to drive the motor vehicle 32, and whether the license 12 will no longer be valid for permitting the associated user to drive the motor vehicle 32 if a condition is not met within a predetermined time period.

If the keyed input is associated with the license 12 and the license 12 is valid, the plurality of indicator lights 26 emits the validation light signal, the screen 28 displays the validation message, and the microprocessor 18 activates the switch 14, thereby enabling the ignition of the vehicle. If either the keyed input is not associated with the license 12, the license 12 is not valid, or both, then the plurality of indicator lights 26 emits the rejection light signal, the screen 28 displays the rejection message, and the switch 14 remains open. If the validation-rejection signal indicates that the license 12 will no longer be valid for permitting the associated user to drive the motor vehicle 32 if a condition is not met within a predetermined time period, the plurality of indicator lights 26 emits the warning light signal and the screen 28 displays the warning message.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A driving violation prevention system comprising:
a license, said license comprising an identification code, said identification code being formatted in a machine-readable medium;
a switch, said switch having an open position and a closed position, said switch disabling ignition of a motor vehicle when open, said switch enabling ignition of the motor vehicle when closed, said switch being biased toward said open position; and
a reader, said reader being operationally coupled to said switch, said reader reading said identification code when said license is positioned in a reading position, said reader being configured for transmitting a query signal to a database requesting a determination of whether said license is valid for permitting an associated user to drive the motor vehicle, said reader being configured for receiving a validation-rejection signal from the database indicating whether said license is valid for permitting the associated user to drive the motor vehicle, said reader closing said switch when the validation-rejection signal indicates that said license is valid for permitting the associated user to drive the motor vehicle.

2. The device of claim 1, further comprising said reader further comprising a microprocessor, said microprocessor being operationally coupled to said switch, said microprocessor closing said switch when the validation-rejection signal indicates that said license is valid for permitting the associated user to drive the motor vehicle.

3. The device of claim 2, further comprising said reader further comprising a license transceiver, said license transceiver being operationally coupled to and in signal communication with said microprocessor, said license transceiver wirelessly transmitting an interrogation signal to said license when said license is positioned in said reading position, said interrogation signal having a radio frequency, said license transceiver wirelessly receiving an identification signal comprising said identification code from said license in response to said interrogation signal, said identification signal having a radio frequency, said license transceiver sending said identification code to said microprocessor.

3. The device of claim 2, further comprising said reader further comprising a database transceiver, said database transceiver being operationally coupled to and in signal communication with said microprocessor, said database transceiver receiving an identification code from said microprocessor, said database transceiver being configured for wirelessly transmitting said query signal to the database and receiving the validation-rejection signal from the database, said database transceiver being configured for sending the validation-rejection signal to said microprocessor.

4. The device of claim 2, further comprising a keypad, said keypad being operationally coupled to and in signal communication with said microprocessor, said keypad being configured for receiving a keyed input from the associated user, said keypad sending said keyed input to said microprocessor, said reader being configured for transmitting the query signal to the database requesting a determination of whether said keyed input is associated with said license, said reader being configured for wirelessly receiving a validation-rejection signal from the database indicating whether said keyed input is associated with said license, said reader closing said switch when the validation-rejection signal indicates that said keyed input is associated with said license and said license is valid for permitting the associated user to drive the motor vehicle.

5. The device of claim 4, further comprising a plurality of indicator lights, said plurality of indicator lights being operationally coupled to said microprocessor,
said plurality of indicator lights emitting a validation light signal if said keyed input is associated with said license, said license is valid for permitting the associated user to drive the motor vehicle, and said switch is closed,
said plurality of indicator lights emitting a rejection light signal if said switch is open and one of said keyed input is not associated with said license and said license is not valid for permitting the associated user to drive the motor vehicle.

6. The device of claim 5, further comprising said reader being configured for wirelessly receiving the validation-rejection signal from the database indicating whether said license will no longer be valid for permitting the associated user to drive the motor vehicle if a condition is not met within a predetermined time period,
said plurality of indicator lights emitting a warning light signal if said keyed input is associated with said license, said license is valid for permitting the associated user to drive the motor vehicle, said switch is closed, and said license will no longer be valid for permitting the associated user to drive the motor vehicle if the condition is not met within the predetermined time period.

7. The device of claim 4, further comprising a screen, said screen being operationally coupled to said microprocessor,
said screen displaying a validation message if said keyed input is associated with said license, said license is valid for permitting the associated user to drive the motor vehicle, and said switch is closed,
said screen displaying a rejection message if said switch is open and one of said keyed input is not associated with said license and said license is not valid for permitting the associated user to drive the motor vehicle.

8. The device of claim 7, further comprising said reader being configured for wirelessly receiving the validation-rejection signal from the database indicating whether said license will no longer be valid for permitting the associated user to drive the motor vehicle if a condition is not met within a predetermined time period,
said screen displaying a warning message if said keyed input is associated with said license, said license is valid for permitting the associated user to drive the motor vehicle, said switch is closed, and said license will no longer be valid for permitting the associated user to drive the motor vehicle if the condition is not met within the predetermined time period.

9. A driving violation prevention system comprising:
a license, said license comprising an identification code, said identification code being formatted in a machine-readable medium;
a switch, said switch having an open position and a closed position, said switch disabling ignition of a motor vehicle when open, said switch enabling ignition of the motor vehicle when closed, said switch being biased toward said open position;
a reader, said reader being operationally coupled to said switch, said reader wirelessly reading said identification code when said license is positioned in a reading position, said reader being capable of receiving a keyed input, said reader being configured for wirelessly transmitting a query signal to a database requesting a determination of whether said keyed input is associated with said license and whether said license is valid for permitting an associated user to drive the motor vehicle, said reader being configured for wirelessly receiving a validation-rejection signal from the database indicating whether said keyed input is associated with said license, whether said license is valid for permitting the associated user to drive the motor vehicle, and whether said license will no longer be valid for permitting the associated user to drive the motor vehicle if a condition is not met within a predetermined time period, said reader closing said switch when the validation-rejection signal indicates that said keyed input is associated with said license and said license is valid for permitting the associated user to drive the motor vehicle, said reader comprising:
a microprocessor, said microprocessor being operationally coupled to said switch, said microprocessor closing said switch when the validation-rejection signal indicates that said keyed input is associated with said license and said license is valid for permitting the associated user to drive the motor vehicle;
a license transceiver, said license transceiver being operationally coupled to and in signal communication with said microprocessor, said license transceiver wirelessly transmitting an interrogation signal to said license when said license is positioned in said reading position, said interrogation signal having a radio frequency, said license transceiver wirelessly receiving an identification signal comprising said identification code from said license in response to said interrogation signal, said identification signal having a radio frequency, said license transceiver sending said identification code to said microprocessor;
a keypad, said keypad being operationally coupled to and in signal communication with said microprocessor, said keypad being configured for receiving said keyed input from the associated user, said keypad sending said keyed input to said microprocessor;
a database transceiver, said database transceiver being operationally coupled to and in signal communication with said microprocessor, said database transceiver receiving said identification code and said keyed input from said microprocessor, said database transceiver being configured for wirelessly transmitting said query signal to the database and receiving the validation-rejection signal from the database, said database transceiver being configured for sending the validation-rejection signal to said microprocessor;
a plurality of indicator lights, said plurality of indicator lights being operationally coupled to said microprocessor,
said plurality of indicator lights emitting a validation light signal if said keyed input is associated with said license, said license is valid for permitting the associated user to drive the motor vehicle, and said switch is closed,
said plurality of indicator lights emitting a rejection light signal if said switch is open and one of said keyed input is not associated with said license and said license is not valid for permitting the associated user to drive the motor vehicle,
said plurality of indicator lights emitting a warning light signal if said keyed input is associated with said license, said license is valid for permitting the associated user to drive the motor vehicle, said switch is closed, and said license will no longer be valid for permitting the associated user to drive the motor vehicle if the condition is not met within the predetermined time period;
a screen, said screen being operationally coupled to said microprocessor,
said screen displaying a validation message if said keyed input is associated with said license, said license is valid for permitting the associated user to drive the motor vehicle, and said switch is closed,
said screen displaying a rejection message if said switch is open and one of said keyed input is not associated with said license and said license is not valid for permitting the associated user to drive the motor vehicle,
said screen displaying a warning message if said keyed input is associated with said license, said license is valid for permitting the associated user to drive the motor vehicle, said switch is closed, and said license will no longer be valid for permitting the associated user to drive the motor vehicle if the condition is not met within the predetermined time period.
